(19) United States
(12) Patent Application Publication
(10) Pub. No.: US 2004/0099162 A1
(43) Pub. Date: May 27, 2004

(54) Printing wheel for tape dispenser and its fabrication method

(76) Inventor: Harrison Huang, Sheng Kang Hsian (TW)

Correspondence Address: BACON & THOMAS, PLLC, 625 SLATERS LANE, FOURTH FLOOR, ALEXANDRIA, VA, 22314

(21) Appl. No.: 10/301,605

(22) Filed: Nov. 22, 2002

(51) Int. Cl. B41K 1/22

(52) U.S. Cl. 101/327

(57) ABSTRACT

The present invention is to provide a method of making a printing wheel for use in a tape dispenser, the method including the step of drawing a plain mother pattern drawing subject to a predetermined unit pattern design, the plain mother pattern drawing having background color zones not to be covered with the ink during printing and assigned color zones to be covered with the ink during printing, and the step of inputting the plain mother pattern drawing into a computer for enabling a computer software program to control an engraving machine to engrave the periphery of a cylindrical hard base material into the desired printing wheel body subject to the design of the plain mother pattern.

### BACKGROUND OF THE INVENTION

1. Field of the Invention

The present invention relates to tape dispensers and, more specifically, to a printing wheel for use in a tape dispenser for printing the adhesive tape being dispensed.

2. Description of the Related Art

U.S. Pat. Nos. 5,947,025 and 6,112,659 respectively disclose a tape dispenser capable of printing patterns and words on the tape dispensed thereby and an adhesive tape dispenser provided with means for printing adhesive tape being dispensed. The printing wheels of the aforesaid two U.S. patents (the printing wheel 30 of U.S. Pat. No. 5,947,025 and the printing cylinder 40 of U.S. Pat. No. 6,112,659) are similar, commonly comprised of a hard wheel body A (generally molded from plastics) and a flexible printing plate B (generally made of rubber), as shown in FIG. 1. The flexible printing plate B has patterns and words formed thereon and, is adhered to the periphery of the wheel body A. Alternatively a packing strip (not shown) may be used to fasten the ends of the flexible printing plate B to the periphery of the wheel body A.

These two printing wheel designs have numerous drawbacks as outlined hereinafter.

1. Because the flexible printing plate is adhered to the periphery of the wheel body or fastened thereto by a packing strip, it tends to be forced out of the wheel body.

2. The flexible printing plate may be not smoothly evenly covered on the periphery of the hard wheel body, resulting in poor printing quality.

3. Due to technique limitations, sufficient space must be left in the four sides of the top surface of the rectangular flexible printing plate around the patterns and words during formation of the patterns and words. When the flexible printing plate rolled up into a roll around the periphery of the wheel body, a big blank area is left around the abutted ends of the flexible printing plate. The installation of the packing strip also requires a big blank area around the abutted ends of the flexible printing plate. When continuously circulating the printing on the adhesive tape being dispensed, an interrupted blank area appears on the adhesive tape being dispensed at every unit distance (the packing strip may produce an ink trace on the adhesive tape being dispensed). On the other words, cannot print a continuous series of patterns and words without leaving a trace of the ends of the flexible printing plate.

4. Because the flexible printing plate is made of rubber, the printing surface of the patterns and words tends to be deformed when contacting the adhesive tape being dispensed, resulting in a vague printing quality. Due to the aforesaid drawbacks, the prior art designs are not suitable for printing fine patterns and fine words.

### SUMMARY OF THE INVENTION

The present invention has been accomplished to provide a printing wheel for a tape dispenser, which eliminates the aforesaid drawbacks. It is therefore the main object of the present invention to provide a printing wheel for tape dispenser, which is durable in use.

It is another object of the present invention to provide a printing wheel for tape dispenser, which achieves a high printing quality.

It is still another object of the present invention to provide a printing wheel fabrication method, which is practical for making printing wheels for tape dispenser that achieve the aforesaid objects.

To achieve these objects of the present invention, the printing wheel fabrication method comprises the steps of a) drawing a plain mother pattern drawing subject to a predetermined unit pattern design, the plain mother pattern drawing having background color zones not to be covered with the ink during printing and assigned color zones to be covered with the ink during printing, the plain mother pattern drawing being defined within a rectangular area having a length and a width corresponding to the length and width of the circumference of the printing wheel to be made; and b) inputting the plain mother pattern drawing into a computer for enabling a computer software program in the computer to control an engraving machine to engrave the periphery of a cylindrical hard base material into a printing wheel body subject to the design of the plain mother pattern, keeping the minor axis and major axis of the rectangular area corresponded to the axis and circumference of the cylindrical hard base material to let the space coordinates of the plain mother pattern drawing be projected onto the circumference of the cylindrical hard base material, so that the circumference of the cylindrical hard base material corresponding to the assigned color zones of the plain mother pattern drawing are maintained intact, and the circumference of the cylindrical hard base material corresponding to the background color zones of the plain mother pattern drawing are cut off subject to a predetermined depth when the cylindrical hard material engraved by the engraving machine.

A printing wheel made according to this method has its printing surface formed integral with the body thereof. Therefore, the printing surface does not fall from the printing wheel body, and has a good roundness. The design printed on the tape being dispensed by the printing wheel has no interrupted portion. Because the printing wheel is made of hard material, the printing surface does not deform during printing. Further, if the lead and tail ends of the major axis of the plain mother pattern drawing are designed to be corresponding to each other, no interruption will exist in the printing surface when the printing wheel body made subject to the designed plain mother pattern drawing.

### BRIEF DESCRIPTION OF THE DRAWINGS

FIG. 1 is an exploded view of a printing wheel for tape dispenser according to the prior art.

FIG. 2 is an exploded view of a printing wheel for tape dispenser according to the present invention.

FIG. 3 is an elevational assembly view of the printing wheel according to the present invention.

FIG. 4 is a sectional view taken along line 4-4 of FIG. 3.

FIG. 5 is an applied view showing the printing wheel installed in a tape dispenser.

FIG. 6 illustrates a mother pattern design for the printing wheel for tape dispenser according to the present invention.

FIG. 7 is a schematic drawing showing connection between the lead and tail ends of a series of the mother pattern design of FIG. 6.

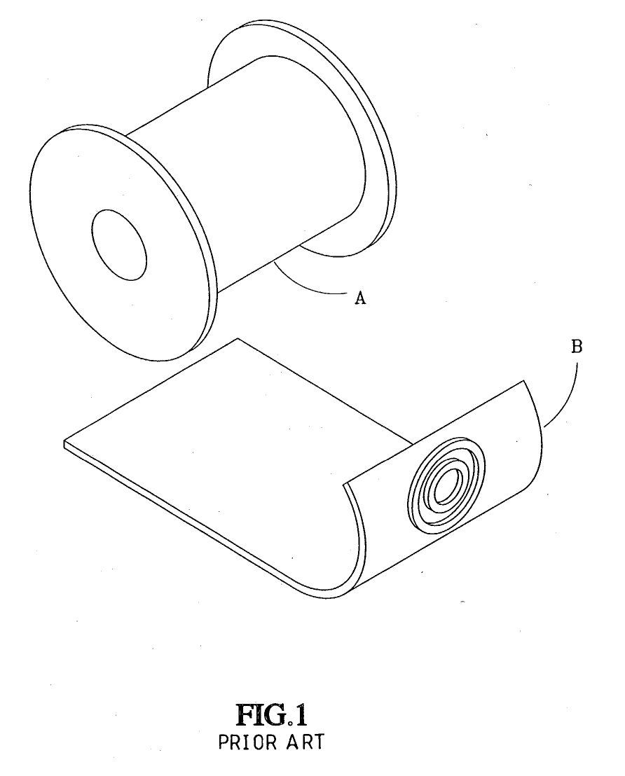

### DETAILED DESCRIPTION OF THE PREFERRED EMBODIMENT

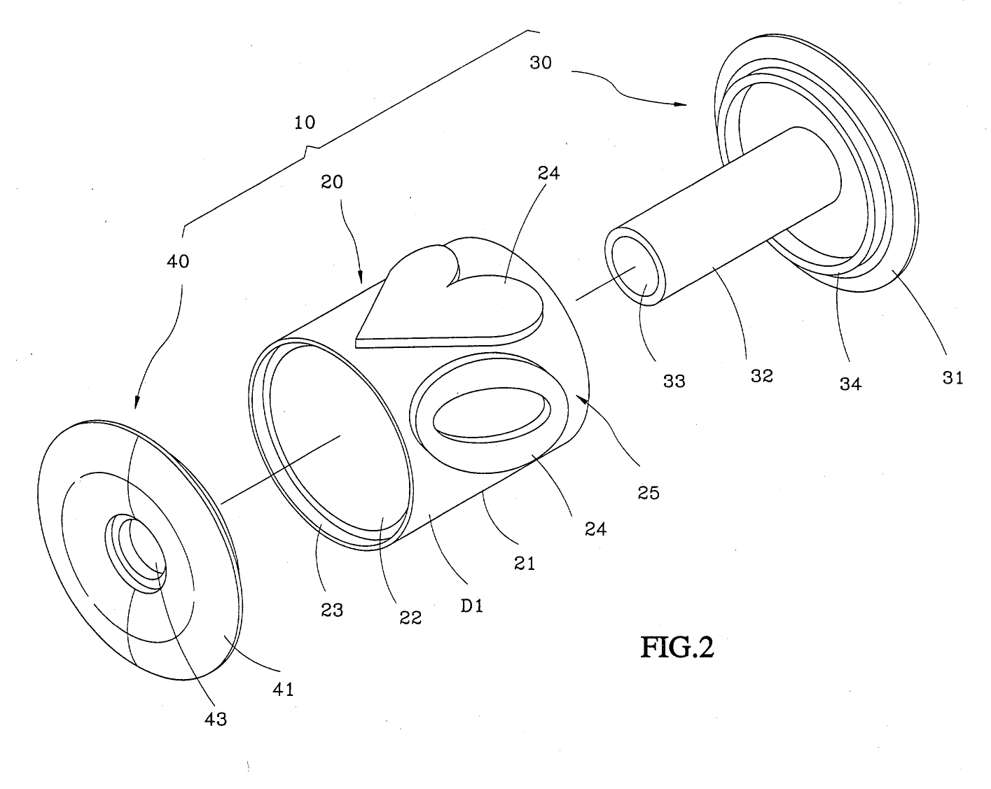

Referring to FIGS. 2-4, a printing wheel 10 in accordance with the present invention is shown comprised of a printing wheel body 20, a first end member 30, and a second end member 40. The printing wheel body 20 is a hollow cylindrical member made of aluminum (or any of a variety of hard materials including metal materials, acrylics, and etc.), having a cylindrical base 21, a through hole 22 axially extended through the two distal ends of the base 21, two inside annular coupling grooves 23 respectively disposed in the two ends of the base 21 around the through hole 22, protruded portions (patterns and words) 24 raised from the periphery D1 of the base 21 and forming a printing surface 25 around the periphery of the base 21. The protruded portions 24 have the same thickness so that the surface of the printing surface 25 is on the same (imaginary) circumference D2, which is coaxial to the base 21 (see FIG. 4). The surface of the printing surface 25 is preferably a coarse surface to facilitate retaining of ink, so that a clear printing can be achieved. The two end members 30 and 40 are respectively injection-molded from plastics. The first end member 30 comprises a disk 31, the disk 31 having a diameter greater than maximum outer diameter of the printing wheel body 20 (the diameter of the aforesaid imaginary circumference D2), a shaft 32 perpendicularly extended from the center of one side, namely, the inner side of the disk 31, an axial center hole 33 axially extended through the center of the shaft 32 and the disk 31, and an annular coupling flange 34 protruded from the inner side of the disk 31 and equally spaced around the shaft 32 and press-fitted into one inside annular coupling groove 23 of the base 21 of the printing wheel body 20. The second end member 40 comprises a disk 41, the disk 41 having an outer diameter equal to the disk 31 of the first end member 30, an axial center hole 43 axially extended through the center of the disk 41, a barrel 42 protruded from the inner side of the disk 41 around the axial center hole 43 and sleeved onto the free end of the shaft 32 of the first end member 30, and an annular coupling flange 44 protruded from the inner side of the disk 41 and equally spaced around the barrel 42 and press-fitted into one inside annular coupling groove 23 of the base 21 of the printing wheel body 20 opposite to the first end member 30.

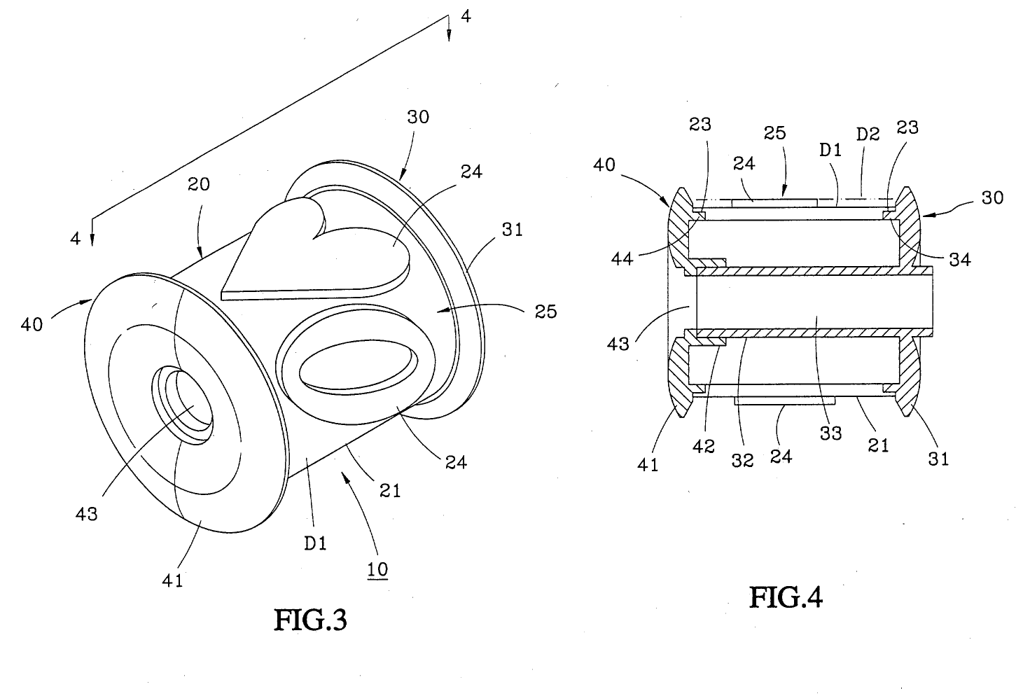

The assembly process of the printing wheel 10 is outlined hereinafter with reference to FIGS. 3 and 4, insert the shaft 32 of the first end member 30 into the through hole 22 of the base 21 of the printing wheel body 20 to force the annular coupling flange 34 into one inside annular coupling groove 23 of the base 21 of the printing wheel body 20, keeping the disk 31 covered on one end of the printing wheel body 20, and then press-fit the annular coupling flange 44 of the second end member 40 into the other inside annular coupling groove 23 of the base 21 of the printing wheel body 20, keeping the sleeved onto the free end of the shaft 32 of the first end member 30. When assembled, the axial center hole 33 of the first end member 30 and the axial center hole 43 of the second end member 40 are axially aligned in the central axis of the printing wheel body 20 in communication with each other. The printing wheel 10 can then be installed in a tape dispenser for printing the tape being dispensed.

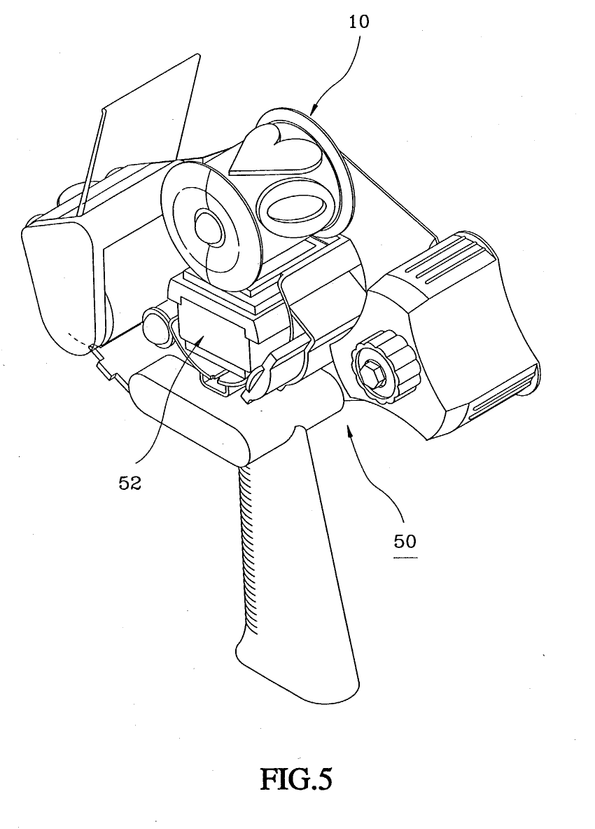

FIG. 5 shows an application example of the present invention. When pivotally installed in the tape dispenser 50, the printing wheel 10 is disposed in contact with the ink supplying device 52 of the tape dispenser 50 (Because the structure of the tape dispenser capable of printing patterns and words on the tape dispensed thereby is of the known art and not within the scope of the claims of the present invention, no further detailed description in the regard is necessary). When dispensing the tape, the printing wheel 10 is rotated by the tape being dispensed, and at the same time the printing surface 25 of the printing wheel body 20 of the printing wheel 10 transfers ink from the sink supplying device 52 to the underside of the tape being dispensed, and therefore the desired design is printed on the underside of the tape being dispensed. Further, because the disks 31 and 41 of the end members 30 and 40 are disposed at the ends of the printing wheel body 20 (see also FIG. 3), the user can conveniently load or unload the printing wheel 10 with the hand, without contaminating the fingers.

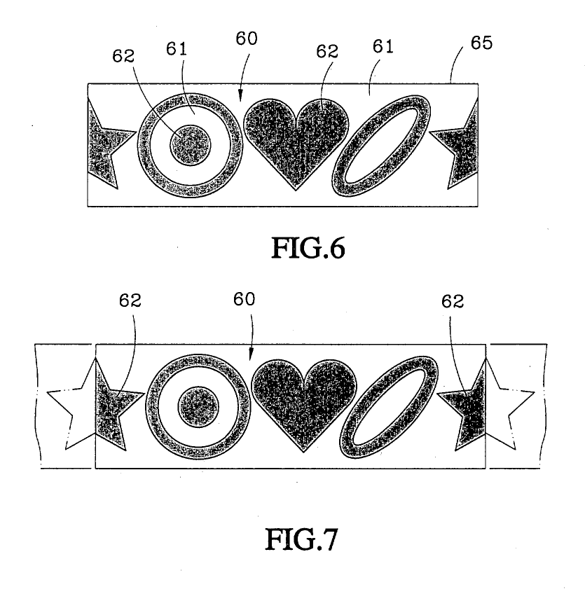

The fabrication method of the printing wheel body 20 is outlined hereinafter. At first, draw a plain mother pattern drawing 60 subject to a predetermined unit pattern design as shown in FIG. 6. The plain mother pattern drawing 60 has background color zones 61 and assigned color zones 62. The background color zones 61 are the ink-free area that does not touch the ink during printing. The assigned color zones 62 are the area to be covered with the ink for printing. The action of drawing the plain mother pattern drawing 60 can be made on a sheet of paper, or through a computer software program. The plain mother pattern drawing 60 is defined within a rectangular area 65. The length and width of the rectangular area 65 correspond to the length and width of the circumference of the printing wheel body 20. The dimensions of the plain mother pattern drawing 60 can be adjusted in the computer software program. Either of drawing the plain mother pattern drawing 60 by hand on a sheet of paper or through a computer software program in a computer, the plain mother pattern drawing 60 thus obtained is inputted into a particular computer software program that controls an engraving machine (conventional equipment) to engrave the periphery of a cylindrical aluminum base material (for the printing wheel body 20) subject to the design of the plain mother pattern drawing 60. It is to be understood that the circumference of the cylindrical aluminum base material is the aforesaid circumference D2 of the printing surface 25. Before engraving, the minor axis and major axis of the rectangular area 65 are corresponded to the axis and circumference of the cylindrical aluminum base material, for enabling the space coordinates of the plain mother pattern drawing 60 to be projected onto the circumference of the cylindrical aluminum base material. During engraving, the circumference of the cylindrical aluminum base material corresponding to the assigned color zones 62 of the plain mother pattern drawing 60 are maintained intact, and the circumference of the cylindrical aluminum base material corresponding to the background color zones 61 of the plain mother pattern drawing 60 are cut off subject to a predetermined depth (the depth is equal to the difference between the aforesaid imaginary circumference D2 and the circumference D1 of the aforesaid printing wheel body 20). After engraving, the engraved cylindrical aluminum base material is further processed into the desired printing wheel body 20 having a printing surface 25 raised from the periphery of the base 21 thereof corresponding to the plain mother pattern drawing 60 (i.e., every protruded portion 24 corresponds to a respective assigned color zone 62). At final, sandblast the periphery of the printing wheel body 20 to coarsen the surface of the printing surface 25, for enabling the printing surface 25 to be easily covered with the ink for printing.

According to the embodiment shown in FIGS. 2-4, the two end members 30 and 40 are separately made, and then fastened to each other and secured to the printing wheel body 20 at two sides. Alternatively, two end disks can be directly formed on the two ends of the engraved cylindrical base material.

According to the aforesaid printing wheel fabrication method, a consumer can design the desired plain mother pattern drawing, and provide the designed plain mother pattern drawing to the printing wheel provider, and the printing wheel provider can make the unique printing wheel subject to the plain mother pattern drawing provided by the consumer. Following fast development of e-commerce, a printing wheel provider can build up a web site in the Internet to accept orders from consumers through the Internet, i.e., a consumer can send a digital data order containing consumer's personal data and the image of the designed plain mother pattern drawing and other necessary specification data through the Internet to the printing wheel provider, asking the printing wheel provider to make the desired printing wheel. When the ordered printing wheel made, the printing wheel provider can dispatch the product to the consumer who gave the order, or asking the consumer to pick up the product.

In comparison with the prior art design, the printing wheel 10 of the present invention has the advantages as follows:

1. Because the printing surface 25 is formed integral with the base 21, the printing surface 25 does not drop from the base 21, and the printing wheel body 20 is durable in use.

2. Because the protruded portions 24 of the printing wheel body 20 are a part of the circumference of the cylindrical aluminum base material before engraving, the finally finished printing surface 25 has a good roundness that can be closely attached to the underside of the tape being dispensed during printing to achieve a high quality printing.

3. Because the printing wheel body 20 is made of hard material (for example, aluminum), the printing surface 25 does not deform during printing, and fine patterns of the design of the printing surface 25 can be clearly printed on the tape being dispensed.

4. As shown in FIGS. 6 and 7, when designing the plain mother pattern drawing 60, enable the lead and tail ends of the major axis of the plain mother pattern drawing 60 to be corresponding to each other, thus no interruption exists in the printing surface 25 when the printing wheel body 20 made subject to the designed plain mother pattern drawing 60. Therefore, the designed pattern design can be repeatedly printed on the underside of the tape being dispensed perfectly.

What the invention claimed is:

1. A method of fabricating a printing wheel for use in a tape dispenser to print a design on the tape being dispensed by said tape dispenser, the method comprising the steps of:
a) drawing a plain mother pattern drawing subject to a predetermined unit pattern design, said plain mother pattern drawing having background color zones not to be covered with the ink during printing and assigned color zones to be covered with the ink during printing, said plain mother pattern drawing being defined within a rectangular area having a length and a width corresponding to the length and width of the circumference of the printing wheel to be made; and
b) inputting said plain mother pattern drawing into a computer for enabling a computer software program in said computer to control an engraving machine to engrave the periphery of a cylindrical hard base material into a printing wheel body subject to the design of said plain mother pattern, keeping the minor axis and major axis of said rectangular area corresponded to the axis and circumference of said cylindrical hard base material to let the space coordinates of said plain mother pattern drawing be projected onto the circumference of said cylindrical hard base material, so that the circumference of said cylindrical hard base material corresponding to said assigned color zones of said plain mother pattern drawing are maintained intact, and the circumference of said cylindrical hard base material corresponding to said background color zones of said plain mother pattern drawing are cut off subject to a predetermined depth when said cylindrical hard material engraved by said engraving machine.

2. The method of claim 1, further comprising step c) processing two distal ends of said cylindrical hard material to form two end disks on the two distal ends of said cylindrical hard base material after step b).

3. The method of claim 1, further comprising a sub-step of sandblasting the circumference of said cylindrical hard base material after step b).

4. The method of claim 1, wherein said plain mother pattern drawing is designed by the user, and sent to a printing wheel provider in a digital data form through a computer network system, for enabling the digital data of said plain mother pattern drawing to be inputted into a computer by said printing wheel provider for engraving the desired printing wheel.

5. A printing wheel for use in a tape dispenser to print a pattern design on the tape being dispensed by said tape dispenser, the printing wheel comprising:
a hard printing wheel body having a cylindrical base, and a plurality of protruded portions raised from the periphery of said cylindrical base and forming a printing surface around the periphery of said cylindrical base, said printing surface being coaxial to said cylindrical base.

6. The printing wheel as claimed in claim 5, wherein said printing wheel further comprises a first disk and a second disk coaxially located on two distal ends of said cylindrical base.

7. The printing wheel as claimed in claim 6, wherein said cylindrical base has an axially extended center through hole; said first disk has a shaft perpendicularly extended from the center of one side thereof and inserted into the axially extended center through hole of said cylindrical base; said second disk has a barrel perpendicularly extended from the center of one side thereof and inserted into the axially extended center through hole of said cylindrical base and press-fitted onto the end of said shaft of said first disk remote from said first disk.

8. The printing wheel as claimed in claim 5, wherein said printing surface has a coarsened surface.

9. A printing wheel for use in a tape dispenser to print a pattern design on the tape being dispensed by said tape dispenser, the printing wheel comprising a hard printing wheel body made subject to the method of claim 1.

10. The printing wheel as claimed in claim 9, wherein said printing wheel body has an axially extended center through hole; the printing wheel further comprises a first end member and a second end member fastened to two distal ends of said printing wheel body, said first end member having a disk stopped at one end of said printing wheel body and a shaft perpendicularly extended from the center of one side of the disk of said first end member and inserted into the axially extended center through hole of said cylindrical base, said second end member having a disk stopped at an opposite end of said printing wheel body and a barrel perpendicularly extended from the center of one side of the disk of said second end member and inserted into the axially extended center through hole of said cylindrical base and press-fitted onto the end of said shaft of said first end member remote from said the disk of said first end member.
